(19) United States
(12) Patent Application Publication
(10) Pub. No.: US 2009/0024287 A1
(43) Pub. Date: Jan. 22, 2009

(54) INTERNAL COMBUSTION ENGINE

(75) Inventor: Jochen Laubender, Markgroeningen (DE)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 12/174,949

(22) Filed: Jul. 17, 2008

(30) Foreign Application Priority Data
Jul. 19, 2007 (DE) 10 2007 033 677.4

(51) Int. Cl. F16H 59/74

(52) U.S. Cl. 701/51; 477/99

(57) ABSTRACT

Internal combustion engine with a power train, to which a torque of a starter can be transferred, wherein the power train is connected to the crankshaft of the internal combustion engine via a clutch, and in so doing, the clutch has an engaged position, wherein a drive torque from the starter can be transferred to the crankshaft, and a disengaged position, wherein the drive torque from the starter cannot be transferred to the crankshaft.

### TECHNICAL FIELD

The invention at hand deals with an internal combustion engine, a method for starting an internal combustion engine as well as a computer program according to the independent claims.

### BACKGROUND

The stop/start method for reducing the fuel consumption and the exhaust gas emissions of a motor vehicle in the so-called “Stop and Go” mode presently continues to gain interest. In the current start-stop systems, the internal combustion engines are started by means of an electric motor, such as, for example, a belt driven starter-generator, a crankshaft-starter-generator or a classic electric starter. With regard to a so-called starter supported start-up of the engine, starting takes place as usual by means of fuel injection and ignition while the crankshaft is rotated by the starter, however with a significantly shortened starter intervention. In so doing, prior to each start-up, the cylinder of the internal combustion engine, which is located in the compression phase, is identified by means of, for example, an absolute angle sensor. Fuel is injected into this cylinder prior to and during the compression phase, and the fuel/air mixture is subsequently compressed with the rotating starter. After passing top dead center (OT) the mixture is ignited. After that the combustion torque, which is thereby produced, always compresses the fuel/air mixture of the subsequent cylinder in the firing order, as is the case in the normal engine operation. For reasons of noise reduction, the starter is thereby only actuated for a short time and deactivated again as soon as possible.

In the case of special variations of currently known electric motors, it is already possible to enmesh the starter in the stop/start mode during the engine run-out. Starters of this kind have a so-called pre-meshing functionality. For that reason, a faster restart of the engine is assured, if, for example, the shut-down of the engine is to be aborted and the engine is started again (so-called Change of Mind, COM). In this way, the internal combustion engine can be transferred as quickly as possible again into the fueled idling mode when a sudden start request appears. The problem with such solutions is that the pre-meshing does not always reliably operate when the crankshaft is still rotating, because, for example, the rotational speed of the starter is not synchronous with the rotational speed of the crankshaft. Moreover, the meshing process is not free from noise. A screeching noise coming from between the teeth of the flywheel ring gear and the drive pinion of the starter can occur when the two go into mesh. An additional disadvantage of this known solution is that the time for restarting the internal combustion engine is relatively long.

### SUMMARY

A task of the invention at hand is for that reason to present an internal combustion engine, a method for starting an internal combustion engine as well as a computer program to implement the method, which allows for a reliable restarting of the engine in a restart-up time, which is shorter than that of the state of the art.

This problem is solved by an internal combustion engine with a power train, to which a torque of a starter can be transferred, wherein the power train is connected to the crankshaft of the internal combustion engine via a clutch, wherein the clutch has an engaged position, in which a drive torque from the starter can be transferred to the crankshaft, and a disengaged position, in which the drive torque of the starter can not be transferred to the crankshaft.

The clutch can preferably be hydraulically, electromagnetically, pneumatically or mechanically actuated between an engaged position and a disengaged position or alternatively is a free-wheel clutch, which allows for a free relative rotation of the crankshaft in its rotational direction vis-à-vis the starter. In a modification, the free-wheel clutch comprises damping elements, which dampen the impact which occurs during meshing.

The power train is preferably a flywheel ring gear, which comprises a gear tooth construction, in which a drive pinion of the starter can be enmeshed or in which said pinion is permanently in mesh.

The power train is alternatively a belt pulley, to which a torque from a belt pulley connected to the starter can be transferred by means of a belt.

The problem mentioned at the beginning of the application can also be solved by a method for starting an internal combustion engine, wherein the coupling is completed in a torque neutral manner.

Provision is preferably made for the starter to initially be brought to a rotational speed, at which the side of the clutch connected to the crankshaft and the side of the clutch connected to the starter have the same rotational speed, and the engagement is thereafter completed.

The problem mentioned at the beginning of the application is also solved by a computer program with a program code for the implementation of all of the steps according to a method, which is in accordance with the invention, if the program is executed on a computer.

### BRIEF DESCRIPTION OF THE DRAWINGS

An example of embodiment of the invention at hand is explained below in detail using the attached drawings. The following are shown:

FIG. 1 is a schematic of a first example of embodiment of an internal combustion engine according to the invention;

FIG. 2 is a schematic of a second example of embodiment of an internal combustion engine according to the invention;

FIG. 3 is a flow diagram of an example of embodiment of a method according to the invention; and

FIG. 4 a flow diagram of an additional example of embodiment of a method according to the invention.

### DETAILED DESCRIPTION

FIG. 1 shows a schematic of a first example of embodiment of an internal combustion engine 1 according to the invention. This comprises in a known manner a crankshaft 2, which is connected to a ring gear 3. In this example of embodiment, the ring gear 3 has an external gearing 4, in which a drive pinion 5 meshes, which is connected to an electrically driven starter 6. An actuable clutch 8 is disposed between a hub flange 7, which is tightly connected to the crankshaft 2, and the ring gear 3. The actuable clutch 8 can be brought into an engaged position by a schematically depicted actuating agent 9, in which the hub flange 7 is connected to the ring gear 3 in a torque proof manner, as well as into a disengaged position, in which no torque transfer is present (except by some possible towing torques or the like) between the hub flange 7 and the ring gear 3. The hub flange 7 can therefore be connected to the crankshaft 2 in a torque proof manner by means of the clutch 8 or can be released from it corresponding to the torque transfer. The drive pinion 5 of the electric starter 6 can thereby be permanently in mesh with the gearing 4 of the ring gear 3 or as is known from the technical field be enmeshed for a start-up procedure or otherwise be disengaged.

The clutch 8 can be a free-wheel clutch instead of an actuable clutch. Said free-wheel clutch allows for a relative rotation of the ring gear 3 vis-à-vis the hub flange 7 and thus the crankshaft 2 and prevents a relative rotation in the other direction. In so doing, a relative rotation of the ring gear 3 vis-à-vis the crankshaft 2 is possible against the direction of rotation of the crankshaft 2 during the operation of the internal combustion engine. Therefore, if the crankshaft 2 rotates faster in its operational direction than the ring gear, the free-wheel clutch then comes into action. If the ring gear 3 rotates faster than the crankshaft 2, this will then be driven by the ring gear. The free-wheel clutch can thereby additionally contain damping elements, for example, rubber elastic elements or friction elements in connection with spring dampers, similar to those which are the case with mass produced flywheels of motor vehicle clutches. Said damping elements and dampers are used to dampen jerky changes in torque.

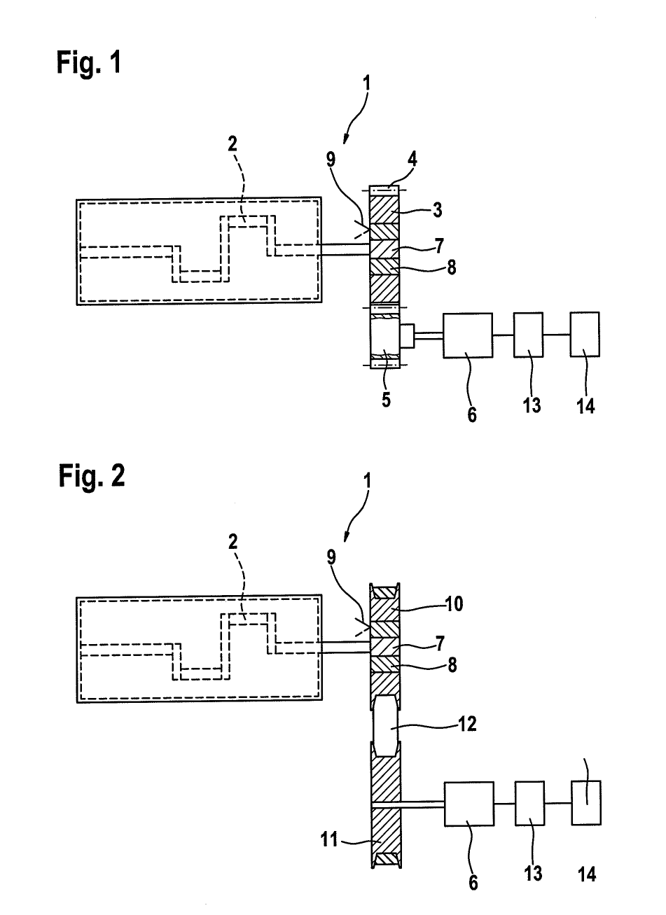

FIG. 2 shows a second example of embodiment of an internal combustion engine according to the invention. The ring gear 3 is replaced in this instance by a belt pulley 10, which otherwise can again be connected to a clutch 8 with a hub 7, which is connected in a torque proof manner to the crankshaft 2. Instead of a drive pinion 5, an additional belt pulley 11 is connected to the starter 6, and in so doing, the belt pulleys 10 and 11 are connected in a known manner to each other by a tractive medium, for example by a V-belt or a toothed belt or the like. The action of the clutch 8 can likewise be actuable or a free-wheel as is the case in the example of embodiment in FIG. 1.

The starter 6 in the examples of embodiment of FIGS. 1 and 2 is open-loop controlled in a known manner by a power control 13, which is activated by a control unit 14.

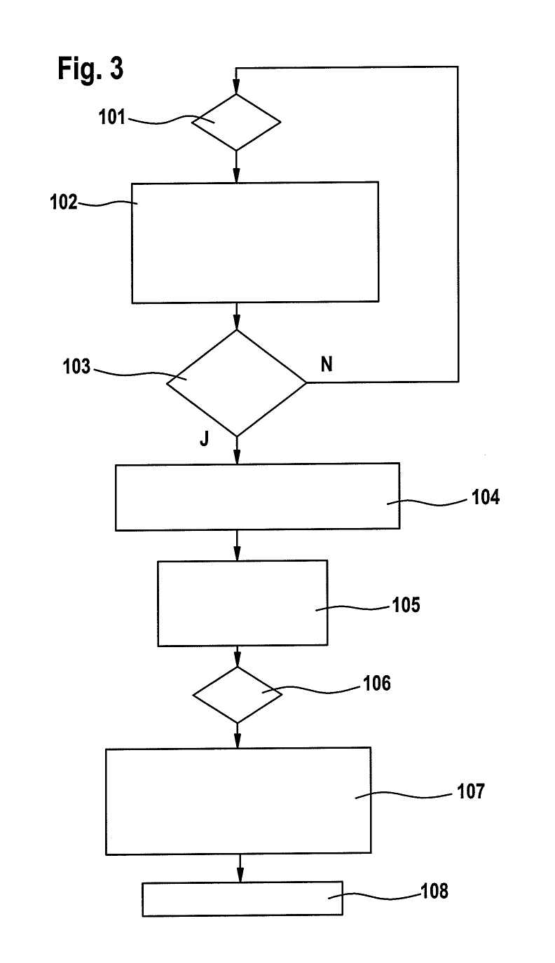

FIG. 3 shows a flow diagram of an example of embodiment of a method according to the invention for starting, respectively restarting, an internal combustion engine. The method begins at step 101 with a pre-starting phase. The pre-starting phase is initiated if the internal combustion engine 1 is stopped in the start/stop mode; and in so doing, a restarting of the engine takes place and not an initial starting after an extended shut-down. In step 102 the relevant signal values of the internal combustion engine, respectively the motor vehicle, are read. These are, for example, the position of the crankshaft, the fuel temperature T_{Kraft}, the ambient air temperature T_{Um}, the oil temperature T_{Öl}, the engine temperature T_{Mot}, the combustion chamber temperature T_{Brennraum}, the intake air temperature T_{Ans}, the temperature of the catalytic converter T_{Kat}, the temperature of the cooling system, respectively the coolant T_{Kühl}, the rail pressure of the high pressure rail P_{Rail} in an internal combustion engine with direct fuel injection, the ambient air pressure P_{Um}, the intake pressure P_{Ans}, the combustion chamber pressure P_{Brennraum}, the voltage U_{Bat} of the starter battery, the octane number of the fuel ROZ used in a gasoline engine, respectively the cetane number or something similar in a diesel engine, the gear, which is engaged, default values for valve control times as well as for valve lift, the compression ε, the position of a charge motion valve, an exhaust gas recirculation rate and the like. A test is made in step 103, which follows the reading of the relevant signal values in step 102, to determine whether conditions for starting the engine exist. If this is answered in the negative, denoted by the option N, the process branches back again to step 101; if this is answered in the affirmative, denoted by the option J, the process branches out to step 104 and the relevant control values for the activation of the starter, the fuel injection as well as the ignition, are read out of a storage device of a control unit of the internal combustion engine. In step 105 the aforementioned values are dispensed, and in step 106 the starting of the internal combustion engine is initiated. After that in step 107, a monitoring of the engine rotational speed, the angle of crankshaft rotation, the engine torque etc. takes place during engine run-up. The coupling between the crankshaft 2 and the ring gear 3, respectively the belt pulley 10, is opened as soon as the internal combustion engine is capable of running without the starter operation, for example, when a minimum engine rotational speed is exceeded. The free-wheel clutch automatically opens if the crankshaft rotation Nmot exceeds a threshold value. With step 108, a stable engine operation follows step 107.

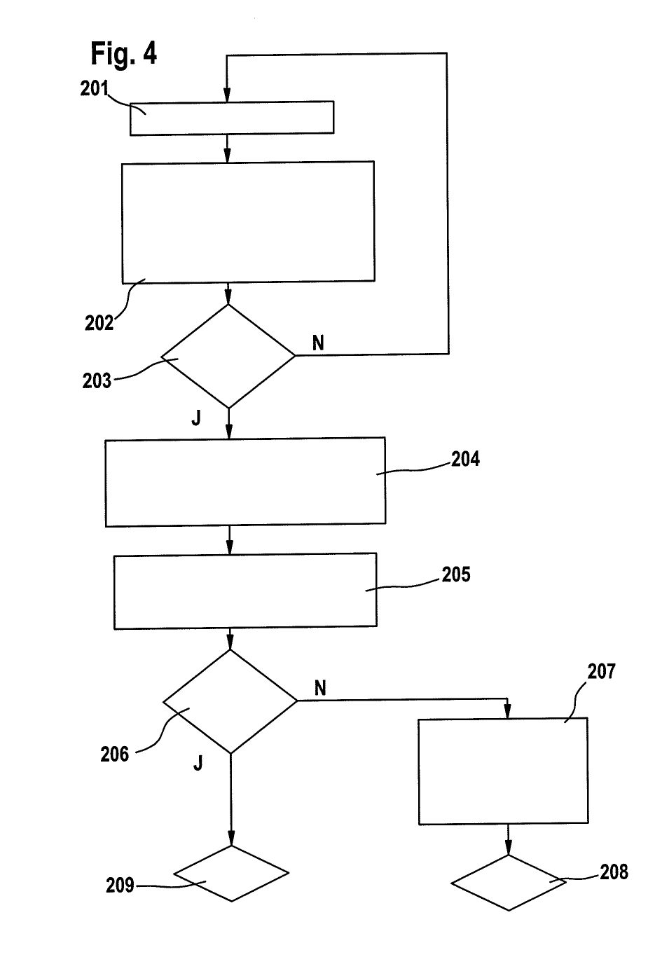

FIG. 4 shows a flow diagram of a method for restarting the internal combustion engine from a stable engine operation. During a stable engine operation, as denoted by step 201, the reading of the relevant signal values of the internal combustion engine, respectively the motor vehicle, takes place in step 202, as previously depicted using step 102 as a basis. After this step, a test is made in a subsequent step 203 to determine whether the conditions for a shut-down of the engine are present. If this is not the case, denoted by the option N, the process then branches back again to step 201. If the conditions for a shut-down of the engine are present, denoted by the option J, the process then branches out to step 204, wherein the fuel injection is gated out and if need be a controlled engine run-out is initiated. The ring gear 3, respectively the belt pulley 10, is brought to a synchronous rotational speed with the crankshaft 2 by the starter 6. After that the monitoring of the engine rotational speed, the angle of crankshaft rotation, the engine torque etc. follows in step 205 during the engine run-out. A test is made in an immediately subsequent step 206 to determine whether a renewed start request is present. If this is not the case, denoted by the option N, the shut-down of the engine continues to be implemented in step 209. If the test in step 206 results in a renewed start request being present during the motor run-out, denoted by the option J, the engagement of the actuable clutch, respectively the free-wheel clutch, results in step 207 from the increase in the rotational speed of the starter and the dispensing of the control values to the starter 6 as well as to the fuel injection and the ignition; whereupon in step 208 a renewed starting of the engine is implemented.

1. An internal combustion engine with a power train comprising:
a starter for generating a drive torque;
a crankshaft; and
a clutch;
wherein the power train is connected to the crankshaft via the clutch; and wherein the clutch has an engaged position and a disengaged position such that in the engaged position the drive torque from the starter can be transferred to the crankshaft, and in the disengaged position the drive torque from the starter cannot be transferred to the crankshaft.

2. The internal combustion engine according to claim 1, wherein the clutch can be hydraulically, electromagnetically, pneumatically or mechanically actuated between the engaged position and the disengaged position.

3. The internal combustion engine according to claim 1, wherein the clutch is a free-wheel clutch that allows for a free relative rotation of the crankshaft in its direction vis-à-vis the starter.

4. The internal combustion engine according to claim 3, wherein the free-wheel clutch comprises one or more damping elements.

5. The internal combustion engine according to claim 1, wherein the power train is a ring gear having a gear tooth construction where a drive pinion of the starter can be enmeshed or is permanently in mesh.

6. The internal combustion engine according to claim 1, wherein the power train is a belt pulley, and wherein a torque of the belt pulley connected to the starter can be transferred via a tractive medium.

7. A method of starting an internal combustion engine including a starter for generating a drive torque; a crankshaft; and a clutch; wherein the engine is connected to the crankshaft via the clutch; and wherein the clutch has an engaged position and a disengaged position such that in the engaged position the drive torque from the starter can be transferred to the crankshaft and in the disengaged position the drive torque from the starter cannot be transferred to the crankshaft; and wherein the clutch can be hydraulically, electromagnetically, pneumatically or mechanically actuated between an engaged position and a disengaged position, the method comprising:
coupling the crankshaft and the starter in a torque free manner.

8. A method according to claim 7, wherein a side of the clutch connected to the crankshaft and a side of the clutch connected to the starter have the same rotational speed.

9. A computer program with a program code stored on a machine-readable carrier to implement, if the program is executed on a computer, a method of starting an internal combustion engine including a starter for generating a drive torque; a crankshaft; and a clutch; wherein the engine is connected to the crankshaft via the clutch; and wherein the clutch has an engaged position and a disengaged position such that in the engaged position the drive torque from the starter can be transferred to the crankshaft and in the disengaged position the drive torque from the starter cannot be transferred to the crankshaft; and wherein the clutch can be hydraulically, electromagnetically, pneumatically or mechanically actuated between an engaged position and a disengaged position, the method comprising: coupling the crankshaft and the starter in a torque free manner.
